(19) United States
(12) Patent Application Publication
(10) Pub. No.: US 2022/0382922 A1
(43) Pub. Date: Dec. 1, 2022

(54) DIGITAL TWIN OBJECTS FOR PRODUCT PACKAGING COMPATIBILITY

(71) Applicant: INTERNATIONAL BUSINESS MACHINES CORPORATION, ARMONK, NY (US)

(72) Inventors: Slobodan Sipcic, Bethesda, MD (US); Peeyush Jaiswal, Boca Raton, FL (US); Priyansh Jaiswal, Boca Raton, FL (US); PAUL LLAMAS VIRGEN, Zapopan (MX); CAROLINA GARCIA DELGADO, Zapopan (MX)

(21) Appl. No.: 17/303,234

(22) Filed: May 25, 2021

(51) Int. Cl. G06F 30/10; G06F 30/20

(52) U.S. Cl. CPC G06F 30/10; G06F 30/20; G06F 2119/18

(57) ABSTRACT

According to one embodiment, a method, computer system, and computer program product for determining packaging compatibility is provided. The embodiment may include creating a digital twin representation of a manufacturing object based on received data of the manufacturing object. The embodiment may include identifying a position of the digital twin representation within a hierarchy of associated digital twin representations. The embodiment may include monitoring for a change to the digital twin representation. The embodiment may include determining a compatibility of a changed digital twin representation within the hierarchy. In response to determining that the changed digital twin representation is incompatible within the hierarchy, the embodiment may include sending an incompatible change alert.

### BACKGROUND

The present invention relates generally to the field of computing, and more particularly to product packaging.

Outsource manufacturing consists of hiring a third-party outside of a company to manufacture components of or build an entire product. The product may represent the entirety of the company's production line or the product may itself be a sub-component of an overall product of the company's production line. A primary driver in a company's decision to outsource its manufacturing needs is its desire to reduce costs. Labor is often among any company's largest costs. As such, a company's decision to outsource one or more parts of its production line to a third-party supplier often results in a significant decrease in production costs for the company. Also, it may be more affordable for a company to outsource parts of its production line to a third-party supplier having a comparative advantage in those production line segments, rather than executing those production processes internally. Many times, one of the greatest advantages of outsourcing manufacturing needs of a company is to utilize assets (e.g., manufacturing facility, equipment) of a third-party which are already in place, thus avoiding the need for the company to invest in its own infrastructure.

### SUMMARY

According to one embodiment, a method, computer system, and computer program product for determining packaging compatibility is provided. The embodiment may include creating a digital twin representation of a manufacturing object based on received data of the manufacturing object. The embodiment may include identifying a position of the digital twin representation within a hierarchy of associated digital twin representations. The embodiment may include monitoring for a change to the digital twin representation. The embodiment may include determining a compatibility of a changed digital twin representation within the hierarchy. In response to determining that the changed digital twin representation is incompatible within the hierarchy, the embodiment may include sending an incompatible change alert.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for a packaging compatibility process, according to at least one embodiment.

FIG. 3A is a diagram depicting a compatible packaging scenario according to at least one embodiment.

FIG. 3B is a table depicting a portion of the compatibility analysis results for the compatible packaging scenario of FIG. 3A, according to at least one embodiment.

FIG. 4A is a diagram depicting an incompatible packaging scenario according to at least one embodiment.

FIG. 4B is a table depicting a portion of the compatibility analysis results for the incompatible packaging scenario of FIG. 4A, according to at least one embodiment.

FIG. 5 is a functional block diagram of internal and external components of computers and servers depicted in FIG. 1 according to at least one embodiment.

FIG. 6 depicts a cloud computing environment according to an embodiment of the present invention.

FIG. 7 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to product packaging. The following described exemplary embodiments provide a system, method, and program product to, among other things, create digital twin representations for multiple manufacturing objects, determine a hierarchy of the created digital twins and, accordingly, determine a packaging compatibility between the digital twins within the hierarchy. Therefore, the present embodiment has the capacity to improve the technical field of smart manufacturing applications by determining whether a proposed change to a digital twin representation of a manufacturing object within a supply chain maintains a packaging compatibility with other digital twins of other manufacturing objects within the supply chain.

As previously described, outsource manufacturing consists of hiring a third-party outside of a company to manufacture components of, or build an entire product. The product may represent the entirety of the company's production line or the product may itself be a sub-component within a supply chain of an overall product of the company's production line. A primary driver in a company's decision to outsource its manufacturing needs is its desire to reduce costs. As such, a company's decision to outsource one or more parts of its production line to a third-party supplier often results in a significant decrease in production costs for the company. Also, it may be more affordable for a company to outsource parts of its production line to a third-party supplier having a comparative advantage in those production line segments, rather than executing those production processes internally. Many times, one of the greatest advantages of outsourcing manufacturing needs of a company is to utilize assets of a third-party which are already in place, thus avoiding the need for the company to invest in its own infrastructure.

While in many cases there are benefits to employing outsource manufacturing, there are also risks associated with using third-party suppliers within a supply chain of a product. For example, a fit packaging problem is a common issue that arises from utilizing third-party suppliers in the introduction of a new product. Consider a scenario in which a company outsources the manufacture of specific parts, such as a bezel part, a rail part, and a cable management assembly, of an overall product to different third-party suppliers. The supplier of the bezel part currently ships the bezel within packaging (e.g., a foam component and a box component) having dimensions which fit into an outer foam component, of an outer box component, that accommodates the packaged bezel part as well as other packaged parts from other suppliers such as a packaged rail part. The outer foam and box components may be supplied by the company or by yet another third-party supplier other than the bezel part supplier and the rail part supplier. Now, suppose in this scenario the supplier of the bezel part introduces a new bezel part (e.g., a modification of the old bezel part) which results in new packaging components for the new bezel part. Suppose further that the new packaging (e.g., the box component) of the new bezel part has dimensions which no longer fit into the outer foam component of the outer box. For instance, the box of the new bezel part is bigger than the box of the old bezel part and consequently does not fit into the outer foam as expected. The involvement of several third-party suppliers within the packaging process represents a high risk that is not properly evaluated until a new product is ready to be delivered. The fit packaging problem described above presents a problem for the company as it will now need to correct the fit packaging issue by expediting corrected boxes from the bezel part supplier, which may be located in another country, or by finding an alternate solution (e.g., setting up local supplier for fitting boxes). Not only can such a problem delay the introduction of products to the market, but also the money loss for companies having to deal with packaging components which do not fit can ascend to millions of dollars per year, per product. It may therefore be imperative to have a system in place to evaluate product packaging combination and fitting analysis for a packaging process before a physical object is created.

Thus, embodiments of the present invention may provide advantages including, but not limited to, digitalizing manufacturing objects (e.g., part components and packaging components), evaluating the fitting between associated digitalized manufacturing objects, and proposing changes to a manufacturing object so as to maintain package fitting compatibility. Further advantages provided by embodiments of the present invention may include the ability to provide a repository of digitalized manufacturing objects which can be exposed and consumed by suppliers as a service to optimize and accelerate delivery processes. Such a service would allow for suppliers to make proper modifications as needed in proofs of concepts before releasing a new product by knowing a priori the impact and feasibility of a modification. The present invention does not require that all advantages need to be incorporated into every embodiment of the invention.

According to at least one embodiment, a digital twin representation of a manufacturing object is created based on data of the manufacturing object received from a supplier of the manufacturing object. According to at least one embodiment, the manufacturing object may be a part component of an overall product or a packaging component utilized within a packaging process of the overall product. The position of the digital twin within a hierarchy of associated digital twins is determined. According to at least one embodiment, digital twin representations of different manufacturing objects may be associated within a hierarchy when the different manufacturing objects are part of an overall product or utilized within a packaging process of the overall product. A determination of whether a change has been performed to the digital twin may be made. According to at least one embodiment, the digital twin of the manufacturing object may be made available to its supplier for editing. Next, a determination of whether the changed digital twin is compatible within the hierarchy of associated digital twins may be made. According to at least one embodiment, the changed digital twin may be incompatible within the hierarchy of associated digital twins based on analysis of dimensions of the changed digital twin and dimensions of the associated digital twins within the hierarchy. An incompatible change alert may be sent to the supplier of the manufacturing object as well as to suppliers of the manufacturing objects represented by the associated digital twins within the hierarchy.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Before describing embodiments of the invention in greater detail, some definitions are provided. The definitions are provided for illustration only and should not be deemed to limit the scope of embodiments of Applicant's disclosed invention. Embodiments of the invention are defined by the claims. Other definitions may be provided throughout the present disclosure, as appropriate.

According to one non-limiting definition, a manufacturing object may refer to any physical object or component that is capable of being represented using computer data. The manufacturing object may have a set of physical and non-physical attributes. The attributes may also be referred to as properties and features. The physical attributes may have states, and these states may undergo change across a dimension, such as time. Two or more changes to states of the physical attributes of the manufacturing object may be referred to as experiences or a history of the manufacturing object.

According to at least one embodiment, the physical attributes of a manufacturing object may include specification of a material composition of the manufacturing object and its individual components (to varying degrees of granularity); dimensions of the manufacturing object (e.g., height, width, length, depth, thickness); a weight of the manufacturing object; dimensions of one or more inner spaces defined within the manufacturing object (e.g., a spaces/voids intended to house one or more other specified child manufacturing objects; the physical arrangements or configurations of the manufacturing object relative to other manufacturing objects; the physical arrangements or configurations of components of the manufacturing object relative to one another or relative to other manufacturing objects; functions of the manufacturing object or its components.

According to at least one embodiment, the non-physical attributes of a manufacturing object may include information that describes the manufacturing object and its physical attributes; a context of the manufacturing object relative to other manufacturing objects or components (e.g., dependencies among manufacturing objects, nesting of manufacturing objects, association with an overall product, association with other manufacturing objects associated with a same overall product); and information that describes the states of the manufacturing object's attributes and the changes in those states over time. Two or more changes to states of the non-physical attributes of the manufacturing object may also be part of the experiences or the history of the manufacturing object.

According to at least one embodiment, the context of the manufacturing object (a non-physical attribute of the manufacturing object) may include information that defines the manufacturing object relative to other manufacturing objects or entities. Non-limiting examples of such context data may include, with respect to a manufacturing object: symbols on associated packaging components; indication of an association with, or being a component of, an overall product or a packaging process of an overall product; an indication of one or more other specified child manufacturing objects being nested/contained within the manufacturing object; an indication of the manufacturing objecting being nested/contained within another specified parent manufacturing object; an indication of the manufacturing object being packaged or assembled into another specified parent manufacturing object; an indication of the manufacturing object being a parent and/or root manufacturing object; an indication of the manufacturing object being a child and/or lowest child manufacturing object; change history; usage history; specifications; 3-dimensional model and CAD drawing data; operating manuals; usage data; artificial intelligence (AI) and state prediction data; operating history; ownership; applicable standards; and ownership terms. Each such type of context data may also have associated change information.

According to one definition, a digital twin refers to a digital representation of a manufacturing object (and more broadly, a computerized representation). In IoT systems, a digital twin can represent an evolving virtual data model that mimics the manufacturing object as well as its experiences and state changes. The digital twin may be said, in an embodiment, to store and track information about its twin manufacturing object.

Accordingly, in at least one embodiment, a digital twin stores and tracks information about physical and non-physical attributes of the manufacturing object; i.e., information that describes the manufacturing object and its physical attributes; a context of the manufacturing object relative to other manufacturing objects or components; and information that describes the states of the manufacturing object's attributes and the changes in those states over time.

For example, the digital twin stores and tracks the material composition of the manufacturing object and its individual components (to varying degrees of granularity); dimensions of the manufacturing object (e.g., height, width, length, depth); an inner space defined within the manufacturing object; the physical arrangements or configurations of the manufacturing object relative to other manufacturing objects; the physical arrangements or configurations of components of the manufacturing object relative to one another or relative to other manufacturing objects; functions of the manufacturing object or its components. The digital twin may also be said to store and track properties or features (i.e., physical and non-physical attributes) of the manufacturing object. The digital twin may also store and track one or more states of the manufacturing object, and these states may change over time.

According to at least one embodiment, a digital twin stores and tracks non-physical attributes of a manufacturing object. Accordingly, the digital twin stores and tracks information that describes the manufacturing object and its physical attributes; and information that describes the states of the physical attributes and the changes in those states over time. Two or more changes to states of the physical attributes and their states may be referred to as experiences or a history of the manufacturing object that the digital twin stores and tracks.

According to at least one embodiment, the digital twin stores and tracks non-physical attributes of a manufacturing object that define a context for the manufacturing object; i.e., information that defines a relationship of the manufacturing object with other manufacturing objects (e.g., dependencies among manufacturing objects, nesting of manufacturing objects, association with an overall product, association with other manufacturing objects associated with a same overall product). Non-limiting examples of such context data stored and tracked as part of the digital may include: indication of an association with, or being a component of, an overall product or a packaging process of an overall product; an indication of another manufacturing object being nested/contained within the manufacturing object; an indication of the manufacturing objecting being nested/contained within another manufacturing object; change history; usage history; specifications; 3-dimensional model and CAD drawing data; operating manuals; usage data; artificial intelligence (AI) and state prediction data; operating history; ownership; applicable standards; and ownership terms. Each such type of context data may also have associated change information.

Certain terms are used interchangeably herein to describe certain embodiments of the inventive systems, processes, and methods. The use of these terms as referencing particular embodiments or figures should not be construed as limiting the scope of the inventive methods or system. By way of example, the terms digital representation, electronic representation, electronic digital representation, electronic log or simply representation are used to refer to a datafile or non-reputable log of the asset. Similarly, the term “asset” is intended to cover any relevant manufacturing object, product, material, component, equipment or machinery.

According to at least one embodiment, the digital twin may be created at the same time as the manufacturing object with similar base features as the initial manufacturing object.

According to at least one other embodiment, the digital twin may be created at a different time than the manufacturing object (for example, before or after the manufacturing object). In an embodiment, the digital twin may be created via a preconfigured data representation of a manufacturing object.

According to at least one embodiment, at any given point in time, regardless of when the digital twin and the manufacturing object are created, the two may be linked. Linking a digital twin and a corresponding manufacturing object may include, for example, a process by which a data record including or representing the digital twin is modified to refer to unique identifying information of the manufacturing object or to reflect any changes to physical and/or non-physical attributes of the manufacturing object.

According to at least one embodiment, creating a digital twin generally refers to a computer-implemented process (implemented by executing programming instructions using a processor) by which a digital record comprising the digital twin is created on a non-transitory tangible storage device. According to at least one embodiment, the storage device is decoupled from the manufacturing object. According to at least one embodiment, the storage device is a component in a cloud-computing infrastructure available in distributed networks and systems such as the interne or IoT systems. Creating a digital twin may also be described as instantiating the digital twin.

The following described exemplary embodiments provide a system, method, and program product to create digital twin representations for multiple manufacturing objects, determine a hierarchy of the created digital twins and, accordingly, determine a packaging compatibility between the digital twins within the hierarchy.

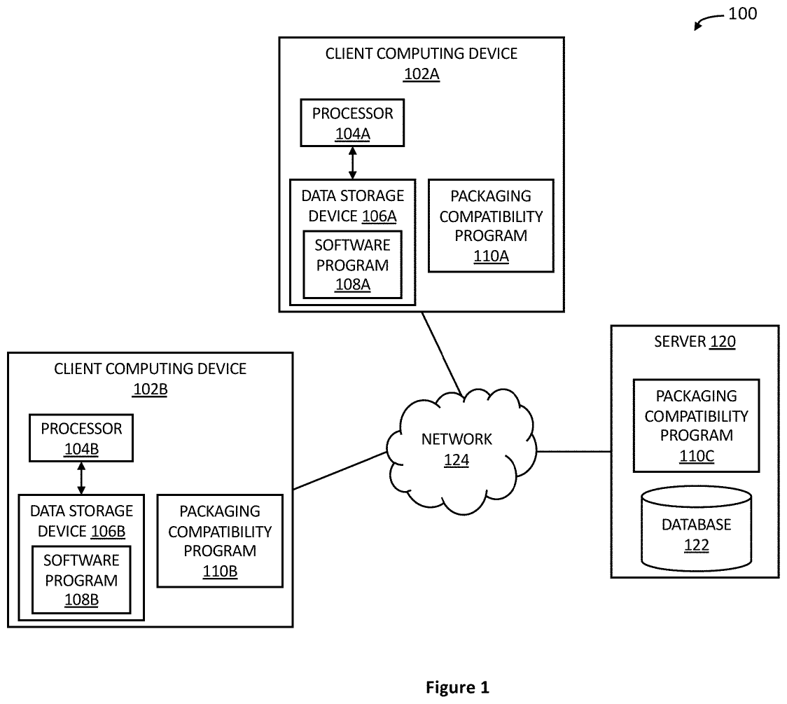

Referring to FIG. 1, an exemplary networked computer environment 100 is depicted, according to at least one embodiment. The networked computer environment 100 may include client computing device 102A, client computing device 102B, and server 120 interconnected via a communication network 124. According to at least one implementation, the networked computer environment 100 may include a plurality of client computing devices 102A, 102B and servers 120. Additionally, in one or more embodiments, the client computing devices 102A, 102B and the server 120 may each host a packaging compatibility program 110A, 110B, 110C. In one or more other embodiments, the packaging compatibility program 110A, 110B, 110C may be partially hosted on both client computing devices 102A, 102B and on server 120 so that functionality may be separated among the devices.

The communication network 124 may include various types of communication networks, such as a wide area network (WAN), local area network (LAN), a telecommunication network, a wireless network, a public switched network and/or a satellite network. The communication network 124 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

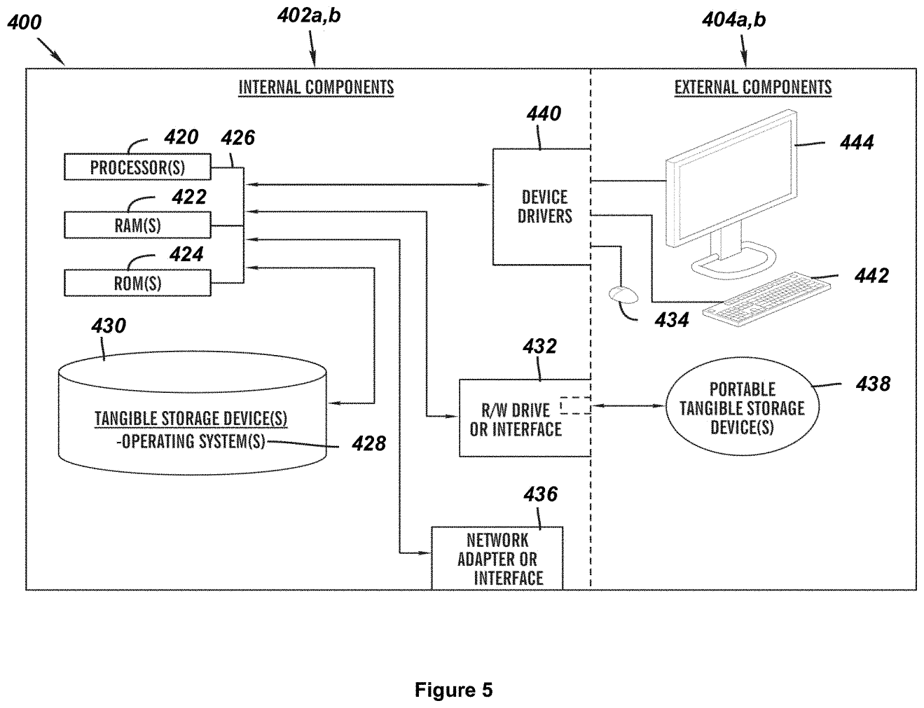

Client computing device 102A, 102B may, respectively, include a processor 104A, 104B and a data storage device 106A, 106B that is enabled to host and run a software program 108A, 108B and a packaging compatibility program 110A, 110B and communicate with the server 120 via the communication network 124, in accordance with one embodiment of the invention. Client computing device 102A, 102B may be, for example, a mobile device, a smartphone, a personal digital assistant, a netbook, a laptop computer, a tablet computer, a desktop computer, or any type of computing device capable of running a program and accessing a network. As will be discussed with reference to FIG. 5, the client computing device 102A, 102B may each include internal components 402a and external components 404a, respectively.

The server computer 120 may be a laptop computer, netbook computer, personal computer (PC), a desktop computer, or any programmable electronic device or any network of programmable electronic devices capable of hosting and running a packaging compatibility program 110C and a database 122 and communicating with the client computing devices 102A, 102B via the communication network 124, in accordance with embodiments of the invention. As will be discussed with reference to FIG. 5, the server computer 120 may include internal components 402b and external components 404b, respectively. The server 120 may also operate in a cloud computing service model, such as Software as a Service (SaaS), Platform as a Service (PaaS), or Infrastructure as a Service (IaaS). The server 120 may also be located in a cloud computing deployment model, such as a private cloud, community cloud, public cloud, or hybrid cloud.

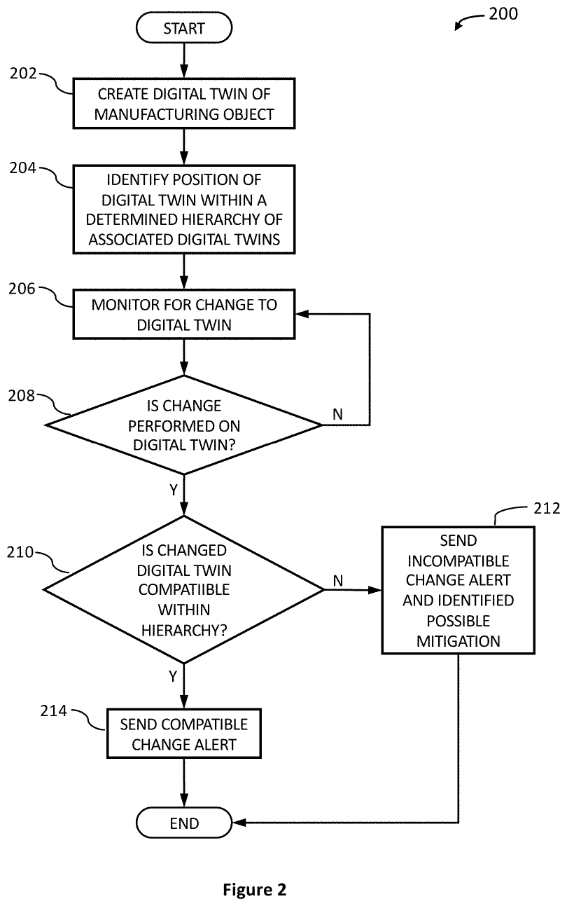

According to the present embodiment, the packaging compatibility program 110A, 110B, 110C may be a program capable of creating a digital twin representation of a manufacturing object based on received data of the manufacturing object, identifying a position of the digital twin representation within a hierarchy/nesting of associated digital twin representations, monitoring for changes to the digital twin representation, determining if a change has occurred to the digital twin representation, determining if the changed digital twin representation is compatible within the hierarchy/nesting, and sending an incompatible change alert along with any identified possible mitigation options. The packaging compatibility method is explained in further detail below with respect to FIG. 2.

Referring now to FIG. 2, an operational flowchart for determining a compatibility of a changed digital twin representation of a manufacturing object within a hierarchy/nesting of associated digital twin representations of other manufacturing objects in a packaging compatibility process 200 is depicted according to at least one embodiment. At 202, the packaging compatibility program 110A, 110B, 110C creates a digital twin representation of a manufacturing object based on data of the manufacturing object received from a supplier of the manufacturing object. The supplier of the manufacturing object may be a third-party supplier and may be the owner, as reflected in an ownership attribute, of the manufacturing object. Utilizing the software program 108A, 108B, the supplier of the manufacturing object may transmit data of the manufacturing object to the packaging compatibility program 110A, 110B, 110C. According to at least one embodiment, data of the manufacturing object may be gathered by the supplier from sources such as, but not limited to, 3-D printers, manufacturing design specifications, 3-D scanners, digital pictures, and software designs. According to at least one other embodiment, the packaging compatibility program 110A, 110B, 110C may gather data of the manufacturing object, from sources such as those previously listed, in response to a request from the supplier to create a digital twin representation of the manufacturing object. According to at least one embodiment, received data of the manufacturing object may include information relating to physical and non-physical attributes of the manufacturing object. Received data of the manufacturing object may also include indication of an association of the manufacturing object with an overall product or with a packaging process of the overall product. Attributes (e.g., physical and non-physical) and any associations of the manufacturing object may be included as metadata of the created digital twin representation of the manufacturing object. The created digital twin representation of the manufacturing object, as well as its metadata, may be stored within database 122.

According to at least one embodiment, packaging compatibility program 110A, 110B, 110C may act as a packaging service and create a separate digital twin representation of every manufacturing object for which it receives data and may store a plurality of created digital twin representations (and their respective metadata) within database 122. Moreover, a supplier may access a created digital twin representation of its manufacturing object stored within database 122 and propose/implement changes to the digital twin representation utilizing the software program 108A, 108B.

Next, at 204, the packaging compatibility program 110A, 110B, 110C identifies a position of the digital twin representation created at 202 within a determined hierarchy/nesting of associated digital twin representations. Packaging compatibility program 110A, 110B, 110C may identify an association between the digital twin representation created at 202 and one or more other digital twin representations stored within database 122 based on analysis of the metadata of each digital twin representation. For example, if metadata of the created digital twin representation indicates that the represented manufacturing object is associated with an overall product or with a packaging process of the overall product, packaging compatibility program 110A, 110B, 110C may associate the created digital twin representation with other digital twin representations stored within database 122 having metadata which indicates an association with the same overall product or with a packaging process of the same overall product. The result is that packaging compatibility program 110A, 110B, 110C identifies associations between all digital twin representations having metadata which indicates an association with a same overall product or with a packaging process of the same overall product.

Continuing with 204, having identified associations between the digital twin representation created at 202 with one or more other digital twin representations having metadata which indicates an association with a same overall product or with a packaging process of the same overall product, packaging compatibility program 110A, 110B, 110C may determine a hierarchy/nesting for all associated digital twin representations and in doing so determine a position of the created digital twin representation within the determined hierarchy/nesting of associated digital twin representations. The determined hierarchy/nesting may be based on analysis of the metadata of the associated digital twin representations. For example, metadata of an associated digital twin may include an indication of another specified manufacturing object being nested/contained within the represented manufacturing object, an indication of the represented manufacturing objecting being nested/contained within another specified manufacturing object, and/or an indication of the represented manufacturing object being packaged or assembled into another specified manufacturing object. From the presence, or lack thereof, of such indications within the metadata of an associated digital twin representation, packaging compatibility program 110A, 110B, 110C may determine a hierarchy/nesting for the associated digital twin representations. For instance, an associated digital twin representation lacking an indication of the represented manufacturing object being nested/contained within another specified manufacturing object or an indication of the represented manufacturing object being packaged or assembled into another specified manufacturing object may be identified as the root of the hierarchy/nesting. Conversely, an associated digital twin representation lacking an indication of another specified manufacturing object being nested/contained within the represented manufacturing object may be identified as the lowest child of the hierarchy/nesting. Digital twin representations positioned between the root and the lowest child of the hierarchy/nesting may be identified according to their respective indications. As such, the position of the created digital twin representation within the determined hierarchy/nesting may be determined. According to at least one embodiment, determined hierarchies/nestings of associated digital twin representations may be stored within database 122.

Next, at 206, the packaging compatibility program 110A, 110B, 110C monitors for any changes made to the digital twin representation created at 202. As noted above, packaging compatibility program 110A, 110B, 110C may allow a supplier to access a stored digital twin representation of its manufacturing object and propose/implement changes to the digital twin representation. More specifically, packaging compatibility program 110A, 110B, 110C may expose created digital twin representations to their respective suppliers, via software program 108A, 108B, so that a supplier of a manufacturing object may make changes to the manufacturing object's physical and/or non-physical attributes tracked and stored within the metadata of the digital twin representation of its manufacturing object.

Next, at 208, the packaging compatibility program 110A, 110B, 110C determines whether a change has been made to the metadata of the digital twin representation, created at 202, by the supplier of the represented manufacturing object. As noted above, metadata of a digital twin representation may track and store physical and non-physical attributes of its represented manufacturing object. According to at least one embodiment, for example, the supplier of the manufacturing object represented by the created digital twin representation may have changed metadata of the digital twin representation corresponding to one or more physical dimensions (e.g., height, length) of the represented manufacturing object in anticipation of such change to the manufacturing object. In response to determining that a change has not occurred (step 208, “No” branch), the packaging compatibility process 200 may return to step 206 to monitor for any changes. In response to determining that a change has occurred to the digital twin representation (step 208, “Yes” branch), the packaging compatibility process 200 may proceed to step 210 to determine whether the changed digital twin representation is compatible within the hierarchy/nesting of associated digital twin representations determined at 204.

Then, at 210, the packaging compatibility program 110A, 110B, 110C determines whether the changed digital twin representation is compatible within the hierarchy/nesting of associated digital twin representations determined at 204. The determination of a compatibility of a changed digital twin representation within a hierarchy/nesting of associated digital twin representations may be based on analysis of the metadata of the changed digital twin representation and the metadata of one or more associated digital twin representations, more specifically, analysis of their respective physical attributes relative to each other.

For example, according to at least one embodiment, a changed digital twin representation identified as a root of a hierarchy/nesting of associated digital twin representations may be determined compatible within the hierarchy/nesting provided that dimensions of any inner spaces defined within the root remain capable of housing the dimensions of any specified child manufacturing objects. More specifically, the dimensions of an inner space defined within the root must remain equal to, or be within acceptable thresholds of, the dimensions of a specified child manufacturing object. An acceptable threshold for a given dimension of the specified child manufacturing object may be based on an acceptance criteria range of plus or minus one percent of the given dimension. A changed dimension falling outside the acceptance criteria range would be determined as incompatible (i.e., not a proper fit). As another example, a changed digital twin representation identified as a lowest child of a hierarchy/nesting of associated digital twin representations may be determined compatible within the hierarchy/nesting provided that dimensions of the lowest child remain capable of fitting into a defined inner space of a specified parent manufacturing object. More specifically, the dimensions of the lowest child must remain equal to, or be within acceptable thresholds of, the dimensions of a defined inner space of the specified parent manufacturing object. An acceptable threshold for a given dimension of the specified parent manufacturing object may be based on an acceptance criteria range of plus or minus one percent of the given dimension. A changed dimension falling outside the acceptance criteria range would be determined as incompatible (i.e., not a proper fit). As yet another example, a changed digital twin representation positioned between a root and a lowest child of a hierarchy/nesting of associated digital twin representations may be determined compatible within the hierarchy/nesting provided that dimensions of any inner spaces defined within the changed digital twin representation remain capable of housing the dimensions of any specified child manufacturing objects and provided that dimensions of the changed digital twin representation remain capable of fitting into a defined inner space of a specified parent manufacturing object. More specifically, the dimensions of an inner space defined within the changed digital twin representation must remain equal to, or be within acceptable thresholds (e.g., +/−1%) of, the dimensions of a specified child manufacturing object and the dimensions of the changed digital twin representation must remain equal to, or be within acceptable thresholds (e.g., +/−1%) of, the dimensions of a defined inner space of the specified parent manufacturing object.

According to at least one other embodiment, dimensions of a specified child manufacturing object may be larger, and exceed acceptable thresholds, than the dimensions of a defined inner space of its specified parent manufacturing object and yet maintain compatibility within a hierarchy/nesting of associated digital twin representations if analysis of the metadata of the digital twin representation of the specified child manufacturing object and/or the digital twin representation of the specified parent manufacturing object specify a material composition of their respective represented manufacturing objects which is flexible and/or compressible.

According to at least one embodiment, the packaging compatibility program 110A, 110B, 110C may limit the compatibility check according to the determined position of the changed digital twin representation within the hierarchy/nesting of associated digital twin representations. For example, the compatibility check may be performed among the changed digital twin representation, an associated digital twin representation positioned immediately above the changed digital twin representation, and/or an associated digital twin representation positioned immediately below the changed digital twin representation. A determined incompatibility of the changed digital twin representation with either of the associated digital twin representation positioned immediately above the changed digital twin representation or the associated digital twin representation positioned immediately below the changed digital twin representation may result in a determination of incompatibility of the changed digital twin representation within the determined hierarchy/nesting of associated digital twin representations.

According to at least one other embodiment, the packaging compatibility program 110A, 110B, 110C may limit the compatibility check according to any child manufacturing object and/or any parent manufacturing object specified within the metadata of the changed manufacturing object. For example, the compatibility check may be performed among the changed digital twin representation, the digital twin representation of a specified child manufacturing object of the changed digital twin representation, and/or the digital twin representation of a specified parent manufacturing object of the changed digital twin representation. A determined incompatibility of the changed digital twin representation with either of the digital twin representation of a specified child manufacturing object of the changed digital twin representation or the digital twin representation of a specified parent manufacturing object of the changed digital twin representation may result in a determination of incompatibility of the changed digital twin representation within the determined hierarchy/nesting of associated digital twin representations.

Continuing with 210, the packaging compatibility program 110A, 110B, 110C may determine whether the changed digital twin representation is compatible with an associated digital twin representation positioned immediately above the changed digital twin representation in the determined hierarchy/nesting of associated digital twin representations, and/or with an associated digital twin representation positioned immediately below the changed digital twin representation in the determined hierarchy/nesting of associated digital twin representations. In response to determining that the changed digital twin representation is incompatible within the determined hierarchy/nesting of associated digital twin representations (step 210, “No” branch), the packaging compatibility process 200 may proceed to step 212. In response to determining that the changed digital twin representation is compatible within the determined hierarchy/nesting of associated digital twin representations (step 210, “Yes” branch), the packaging compatibility process 200 may proceed to step 214.

According to at least one embodiment, at 212, the packaging compatibility program 110A, 110B, 110C may reject the changed digital twin representation and send an incompatible change alert, via the software program 108A, 108B, to the supplier proposing/implementing the change to the digital twin representation created at 202, as well as to every supplier owning a manufacturing object having a digital twin representation associated with the created digital twin representation. According to at least one other embodiment, the packaging compatibility program 110A, 110B, 110C may send the incompatible change alert to every supplier owning a manufacturing object having a digital twin representation within the hierarchy/nesting of digital twin representations associated with the digital twin representation created at 202. Furthermore, according to at least one embodiment, the packaging compatibility program 110A, 110B, 110C may also identify and send, along with the incompatibility change alert, one or more possible mitigation suggestions for the incompatible change. A mitigation suggestion may include, but is not limited to, a rollback of the incompatible change and/or an alternate change to the created digital twin representation which maintains compatibility.

According to at least one other embodiment, the packaging compatibility program 110A, 110B, 110C may limit the sending of the incompatible change alert and the one or more possible mitigation suggestions to the supplier proposing/implementing the change to the created digital twin representation.

According to at least one embodiment, at 214, the packaging compatibility program 110A, 110B, 110C may accept the changed digital twin representation and send a compatible change alert, via the software program 108A, 108B, to the supplier proposing/implementing the change to the digital twin representation created at 202, as well as to every supplier owning a manufacturing object having a digital twin representation associated with the created digital twin representation. According to at least one other embodiment, the packaging compatibility program 110A, 110B, 110C may send the compatible change alert to every supplier owning a manufacturing object having a digital twin representation within the hierarchy/nesting of digital twin representations associated with the created digital twin representation.

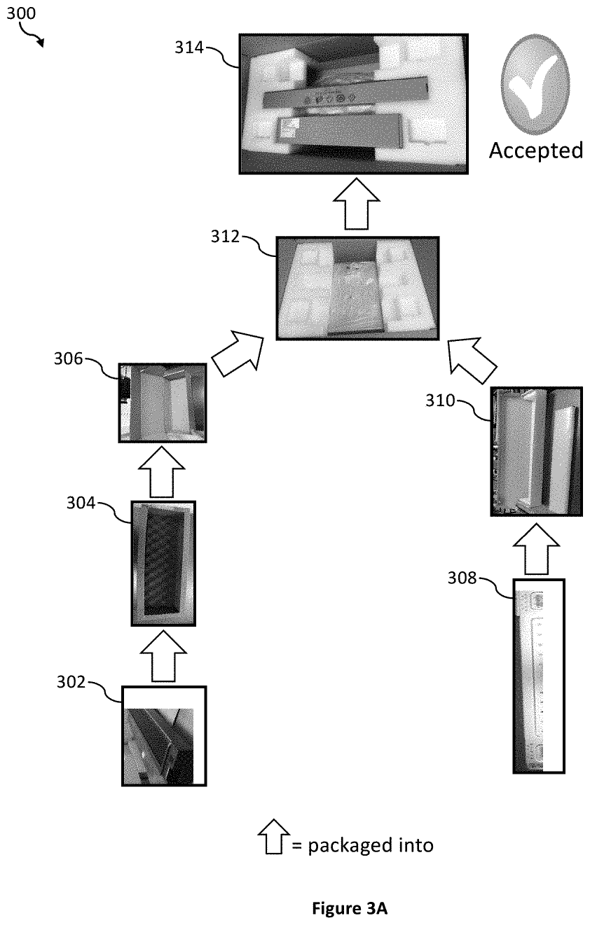

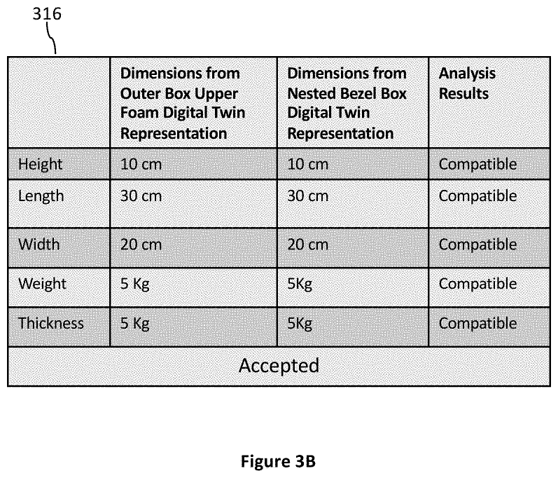

Referring now to FIG. 3A, a diagram depicting a compatible packaging scenario 300 is shown according to at least one embodiment. As depicted in FIG. 3A, bezel part 302 is packaged into bezel foam 304, which is packaged into bezel box 306. Also depicted in FIG. 3A, rail part 308 is packaged into rail box with inner foam 310. Bezel box 306 (containing bezel part 302 and bezel foam 304) and rail box with inner foam 310 (containing rail part 308) are both packaged into outer box upper foam 312, which is then packaged into outer box 314. In this compatible packaging scenario 300, each item 302-314 may be considered a manufacturing object. Furthermore, a first supplier may manufacture objects bezel part 302, bezel foam 304, and bezel box 306; a second supplier may manufacture objects rail part 308, and rail box with inner foam 310; and a third supplier may manufacture objects outer box upper foam 312, and outer box 314. Utilizing the packaging compatibility program 110A, 110B, 110C of FIG. 1 as a packaging service, the first, second, and third supplier may send data for each of their respective manufacturing objects to packaging compatibility program 110A, 110B, 110C which then creates a digital twin representation for each item 302-314 which may be stored within database 122 of FIG. 1. Moreover, the packaging compatibility program 110A, 110B, 110C determines associations between, and a hierarchy/nesting for, the digital twin representations of 302-314. For instance, metadata of the digital twin representation for bezel box 306 and metadata of the digital twin representation for inner foam 310 may indicate outer box upper foam 312 as a specified parent manufacturing object. Similarly, metadata of the digital twin representation for outer box upper foam 312 may indicate bezel box 306 and inner foam 310 as specified child manufacturing objects. The determined associations and hierarchy/nesting may also be stored within database 122. As is shown in FIG. 3A, bezel box 306 and rail box with inner foam 310 fit as expected within outer box upper foam 312, as such the corresponding digital twin representations for bezel box 306, inner foam 310, and outer box upper foam 312 are determined to be compatible and accepted by the packaging compatibility program 110A, 110B, 110C.

FIG. 3B depicts a table 316 which summarizes a portion of the analysis between the metadata of the digital twin representation for outer box upper foam 312 and the metadata of the digital twin representation for bezel box 306, more specifically, comparison of their respective tracked and stored physical attributes relative to each other. As shown in table 316, the height, length, width, weight, and thickness physical dimensions of outer box upper foam 312 and bezel box 306 are equal to each other and thus compatible.

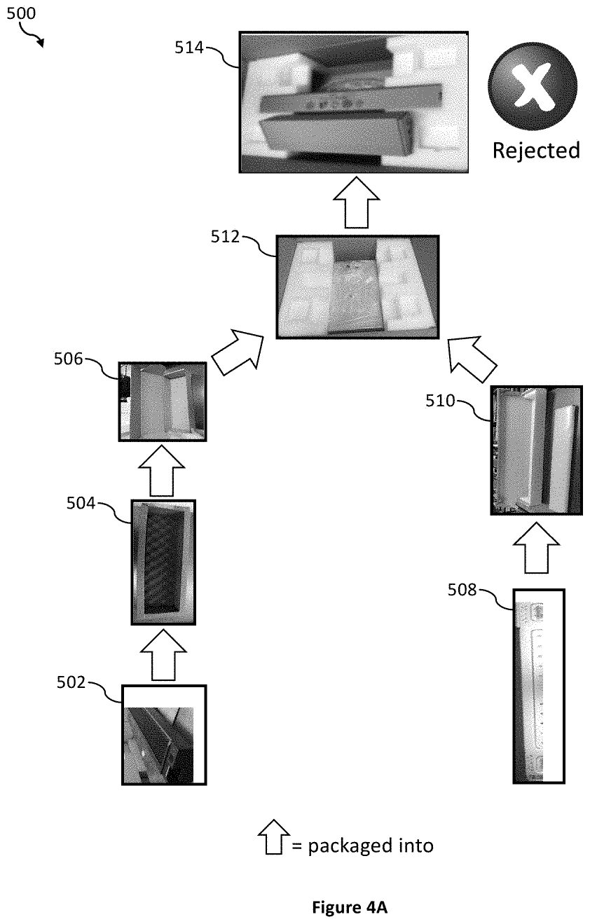

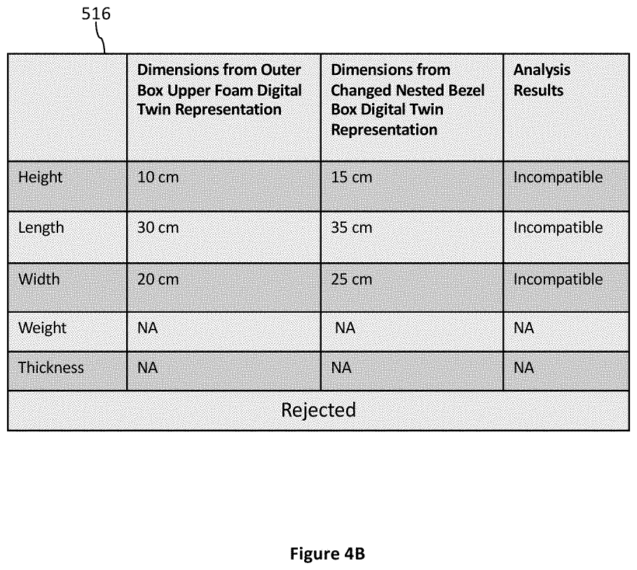

Referring now to FIG. 4A, a diagram depicting an incompatible packaging scenario 500 is shown according to at least one embodiment. As depicted in FIG. 4A, bezel part 502 is packaged into bezel foam 504, which is packaged into bezel box 506. Also depicted in FIG. 4A, rail part 508 is packaged into rail box with inner foam 510. Bezel box 506 (containing bezel part 502 and bezel foam 504) and rail box with inner foam 510 (containing rail part 508) are both packaged into outer box upper foam 512, which is then packaged into outer box 514. In this compatible packaging scenario 500, each item 502-514 may be considered a manufacturing object. Furthermore, a first supplier may manufacture objects bezel part 502, bezel foam 504, and bezel box 506; a second supplier may manufacture objects rail part 508, and rail box with inner foam 510; and a third supplier may manufacture objects outer box upper foam 512, and outer box 514. Utilizing the packaging compatibility program 110A, 110B, 110C of FIG. 1 as a packaging service, the first, second, and third supplier may send data for each of their respective manufacturing objects to packaging compatibility program 110A, 110B, 110C which then creates a digital twin representation for each of 502-514 which may be stored within database 122 of FIG. 1. Moreover, the packaging compatibility program 110A, 110B, 110C determines associations between, and a hierarchy/nesting for, the digital twin representations of 502-514. For instance, metadata of the digital twin representation for bezel box 506 and metadata of the digital twin representation for rail box with inner foam 510 may indicate outer box upper foam 512 as a specified parent manufacturing object. Similarly, metadata of the digital twin representation for outer box upper foam 512 may indicate bezel box 506 and rail box with inner foam 510 as specified child manufacturing objects. The determined associations and hierarchy/nesting may also be stored within database 122. As is shown in FIG. 4A, bezel box 506 does not fit as expected within outer box upper foam 512. This fitting issue may be the result of a change made to one or more physical dimensions of bezel box 506 by its supplier. As such, the corresponding digital twin representations for bezel box 506 and outer box upper foam 512 are determined to be incompatible and the change(s) made to bezel box 506 is rejected by the packaging compatibility program 110A, 110B, 110C.

FIG. 4B depicts a table 516 which summarizes a portion of the analysis between the metadata of the digital twin representation for outer box upper foam 512 and the metadata of the digital twin representation for bezel box 506, more specifically, comparison of their respective tracked and stored physical attributes relative to each other. As shown in table 516, the height, length, and width physical dimensions of bezel box 512 and bezel box 506 are not equal to each other and thus are incompatible.

It may be appreciated that FIGS. 2, 3A, 3B, 4A, and 4B provide only an illustration of one implementation and do not imply any limitations with regard to how different embodiments may be implemented. Many modifications to the depicted environments may be made based on design and implementation requirements.

FIG. 5 is a block diagram 400 of internal and external components of the client computing device 102A, the client computing device 102B, and the server 120 depicted in FIG. 1 in accordance with an embodiment of the present invention. It should be appreciated that FIG. 5 provides only an illustration of one implementation and does not imply any limitations with regard to the environments in which different embodiments may be implemented. Many modifications to the depicted environments may be made based on design and implementation requirements.

The data processing system 402, 404 is representative of any electronic device capable of executing machine-readable program instructions. The data processing system 402, 404 may be representative of a smart phone, a computer system, PDA, or other electronic devices. Examples of computing systems, environments, and/or configurations that may represented by the data processing system 402, 404 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102A, the client computing device 102B, and the server 120 may include respective sets of internal components 402 a,b and external components 404 a,b illustrated in FIG. 5. Each of the sets of internal components 402 include one or more processors 420, one or more computer-readable RAMs 422, and one or more computer-readable ROMs 424 on one or more buses 426, and one or more operating systems 428 and one or more computer-readable tangible storage devices 430. The one or more operating systems 428, the software program 108A and the packaging compatibility program 110A in the client computing device 102A, the software program 108B and the packaging compatibility program 110B in the client computing device 102B, and the packaging compatibility program 110C in the server 120 are stored on one or more of the respective computer-readable tangible storage devices 430 for execution by one or more of the respective processors 420 via one or more of the respective RAMs 422 (which typically include cache memory). In the embodiment illustrated in FIG. 5, each of the computer-readable tangible storage devices 430 is a magnetic disk storage device of an internal hard drive. Alternatively, each of the computer-readable tangible storage devices 430 is a semiconductor storage device such as ROM 424, EPROM, flash memory or any other computer-readable tangible storage device that can store a computer program and digital information.

Each set of internal components 402 a,b also includes a R/W drive or interface 432 to read from and write to one or more portable computer-readable tangible storage devices 438 such as a CD-ROM, DVD, memory stick, magnetic tape, magnetic disk, optical disk or semiconductor storage device. A software program, such as the packaging compatibility program 110A, 110B, 110C, can be stored on one or more of the respective portable computer-readable tangible storage devices 438, read via the respective R/W drive or interface 432, and loaded into the respective hard drive 430.

Each set of internal components 402 a,b also includes network adapters or interfaces 436 such as a TCP/IP adapter cards, wireless Wi-Fi interface cards, or 3G or 4G wireless interface cards or other wired or wireless communication links. The software program 108A and the packaging compatibility program 110A in the client computing device 102A, the software program 108B and the packaging compatibility program 110B in the client computing device 102B, and the packaging compatibility program 110C in the server 120 can be downloaded to the client computing device 102A, the client computing device 102B, and the server 120 from an external computer via a network (for example, the Internet, a local area network or other, wide area network) and respective network adapters or interfaces 436. From the network adapters or interfaces 436, the software program 108A and the packaging compatibility program 110A in the client computing device 102A, the software program 108B and the packaging compatibility program 110B in the client computing device 102B, and the packaging compatibility program 110C in the server 120 are loaded into the respective hard drive 430. The network may comprise copper wires, optical fibers, wireless transmission, routers, firewalls, switches, gateway computers and/or edge servers.

Each of the sets of external components 404 a,b can include a computer display monitor 444, a keyboard 442, and a computer mouse 434. External components 404 a,b can also include touch screens, virtual keyboards, touch pads, pointing devices, and other human interface devices. Each of the sets of internal components 402 a,b also includes device drivers 440 to interface to computer display monitor 444, keyboard 442, and computer mouse 434. The device drivers 440, R/W drive or interface 432, and network adapter or interface 436 comprise hardware and software (stored in storage device 430 and/or ROM 424).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

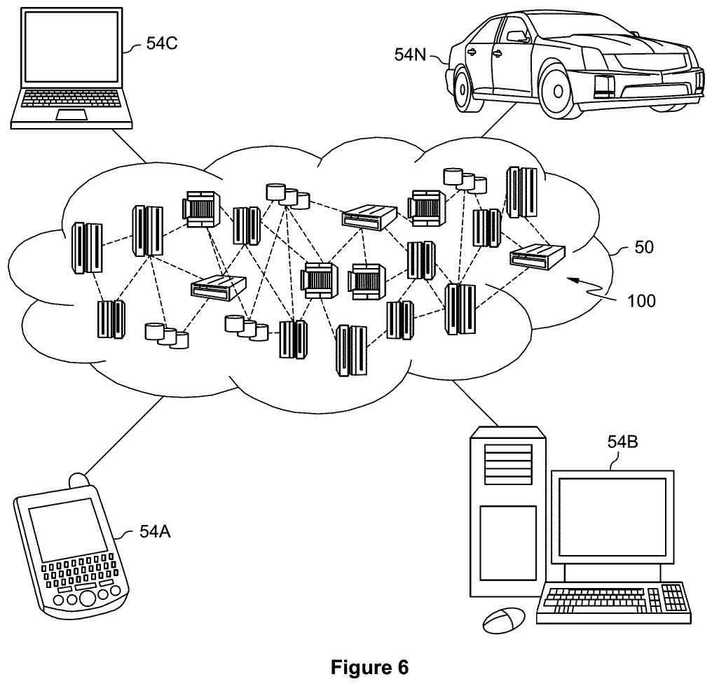

Referring now to FIG. 6, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 100 and cloud computing environment 50 can communicate with any type of computerized device over any type of network and/or network addressable connection (e.g., using a web browser).

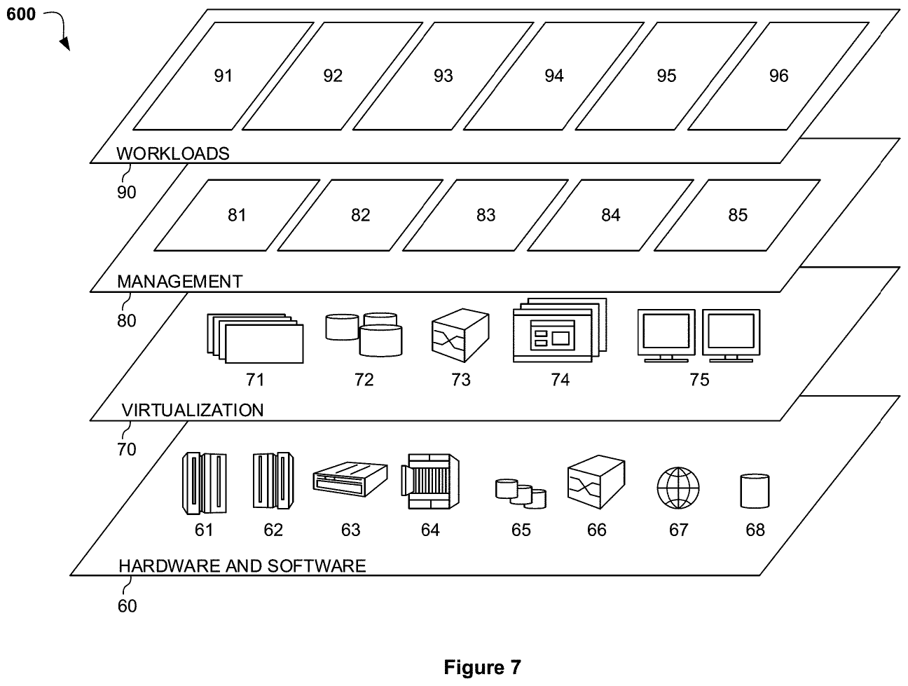

Referring now to FIG. 7, a set of functional abstraction layers 600 provided by cloud computing environment 50 is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and determining packaging compatibility 96. Determining packaging compatibility 96 may relate to determining a compatibility of a changed digital twin representation of a manufacturing object with other digital twin representations of associated manufacturing objects.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method of determining packaging compatibility, the method comprising:
creating a digital twin representation of a manufacturing object based on received data of the manufacturing object;
identifying a position of the digital twin representation within a hierarchy of associated digital twin representations;
monitoring for a change to the digital twin representation;
determining a compatibility of a changed digital twin representation within the hierarchy; and
in response to determining that the changed digital twin representation is incompatible within the hierarchy, sending an incompatible change alert.

2. The method of claim 1, further comprising:
in response to determining that the changed digital twin representation is compatible within the hierarchy, sending a compatible change alert.

3. The method of claim 1, wherein the received data of the manufacturing object is received from a supplier of the manufacturing object.

4. The method of claim 1, wherein the digital twin representation comprises metadata, and wherein the metadata comprises physical attributes, non-physical attributes, and any associations of the manufacturing object.

5. The method of claim 4, wherein associations of the digital twin representation and the hierarchy of associated digital twin representations are based on based on analysis of the metadata of the digital twin representation and respective metadata of the associated digital twin representations.

6. The method of claim 4, wherein determining the compatibility is based on analysis of the physical attributes of the metadata of the digital twin representation and analysis of physical attributes of the respective metadata of the associated digital twin representations.

7. The method of claim 1, wherein the incompatible change alert is sent to a supplier of the manufacturing object and one or more suppliers of manufacturing objects represented by the associated digital twin representations, and wherein the incompatible change alert comprises an identified mitigation.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
creating a digital twin representation of a manufacturing object based on received data of the manufacturing object;
identifying a position of the digital twin representation within a hierarchy of associated digital twin representations;
monitoring for a change to the digital twin representation;
determining a compatibility of a changed digital twin representation within the hierarchy; and
in response to determining that the changed digital twin representation is incompatible within the hierarchy, sending an incompatible change alert.

9. The computer system of claim 8, further comprising:
in response to determining that the changed digital twin representation is compatible within the hierarchy, sending a compatible change alert.

10. The computer system of claim 8, wherein the received data of the manufacturing object is received from a supplier of the manufacturing object.

11. The computer system of claim 8 wherein the digital twin representation comprises metadata, and wherein the metadata comprises physical attributes, non-physical attributes, and any associations of the manufacturing object.

12. The computer system of claim 11, wherein associations of the digital twin representation and the hierarchy of associated digital twin representations are based on based on analysis of the metadata of the digital twin representation and respective metadata of the associated digital twin representations.

13. The computer system of claim 11, wherein determining the compatibility is based on analysis of the physical attributes of the metadata of the digital twin representation and analysis of physical attributes of the respective metadata of the associated digital twin representations.

14. The computer system of claim 8, wherein the incompatible change alert is sent to a supplier of the manufacturing object and one or more suppliers of manufacturing objects represented by the associated digital twin representations, and wherein the incompatible change alert comprises an identified mitigation.

15. A computer program product, the computer program product comprising:
one or more computer-readable tangible storage medium and program instructions stored on at least one of the one or more tangible storage medium, the program instructions executable by a processor capable of performing a method, the method comprising:
creating a digital twin representation of a manufacturing object based on received data of the manufacturing object;
identifying a position of the digital twin representation within a hierarchy of associated digital twin representations;
monitoring for a change to the digital twin representation;
determining a compatibility of a changed digital twin representation within the hierarchy; and
in response to determining that the changed digital twin representation is incompatible within the hierarchy, sending an incompatible change alert.

16. The computer program product of claim 15, further comprising:
in response to determining that the changed digital twin representation is compatible within the hierarchy, sending a compatible change alert.

17. The computer program product of claim 15, wherein the received data of the manufacturing object is received from a supplier of the manufacturing object.

18. The computer program product of claim 15, wherein the digital twin representation comprises metadata, and wherein the metadata comprises physical attributes, non-physical attributes, and any associations of the manufacturing object.

19. The computer program product of claim 18, wherein associations of the digital twin representation and the hierarchy of associated digital twin representations are based on based on analysis of the metadata of the digital twin representation and respective metadata of the associated digital twin representations.

20. The computer program product of claim 18, wherein determining the compatibility is based on analysis of the physical attributes of the metadata of the digital twin representation and analysis of physical attributes of the respective metadata of the associated digital twin representations.
